(19) United States
(12) Patent Application Publication
(10) Pub. No.: US 2024/0056964 A1
(43) Pub. Date: Feb. 15, 2024

(54) NETWORK OPERATION TIME INTERVAL INDICATION

(71) Applicant: QUALCOMM Incorporated, San Diego, CA (US)

(72) Inventors: Ahmed Attia Abotabl, San Diego, CA (US); Yu Zhang, San Diego, CA (US); Hung Dinh Ly, San Diego, CA (US)

(21) Appl. No.: 17/885,172

(22) Filed: Aug. 10, 2022

(51) Int. Cl. H04W 52/02; H04W 24/02

(52) U.S. Cl. CPC H04W 52/0203; H04W 52/0235; H04W 24/02

(57) ABSTRACT

Methods, systems, and devices for wireless communication are described. A user equipment (UE) may receive, from a network entity, control signaling indicating multiple network energy saving states of the network entity. The UE and the network entity may communicate one or more messages in accordance with a first energy saving state of the multiple network energy saving states. The one or more messages that are communicated may be based on a time period associated with the first network energy saving state, based on receiving a control message indicating that the first network energy saving state is active, or both.

### FIELD OF TECHNOLOGY

The following relates to wireless communication, including network operation time interval indication.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a UE and a network entity may support different communication states to support varying levels of system traffic. Some communication states, however, may be costly in terms of relative power consumption, so the UE and the network entity may perform network energy saving (NES) procedures to increase energy savings.

### SUMMARY

The described techniques relate to improved methods, systems, devices, and apparatuses that support network operation time interval indication. Generally, the described techniques provide for a user equipment (UE) to receive control signaling from a network entity, where the control signaling may indicate one or more network energy saving (NES) states implemented by the network entity. In one example, the control signaling may indicate a time pattern associated with the multiple NES states. For example, the UE may be configured with a time sequence of NES states to allocate time intervals for enhanced energy savings based on the traffic level. Additionally or alternatively, the control signaling may include a control message that indicates a NES state is active. For example, the UE may be explicitly configured by the network entity with an indication of the NES state. Based on the NES state signaled to the UE, the UE may modify transmission and reception parameters, communication techniques, or both, to communicate with the network entity.

A method for wireless communication at a UE is described. The method may include receiving, from a network entity, control signaling indicating a set of multiple NES states of the network entity and communicating one or more messages with the network entity in accordance with a first NES state of the set of multiple NES states, the one or more messages being communicated based on a time period associated with the first NES state, based on receiving a control message indicating that the first NES state is active, or both.

An apparatus for wireless communication at a UE is described. The apparatus may include a processor, memory coupled with the processor, and instructions stored in the memory. The instructions may be executable by the processor to cause the apparatus to receive, from a network entity, control signaling indicating a set of multiple NES states of the network entity and communicate one or more messages with the network entity in accordance with a first NES state of the set of multiple NES states, the one or more messages being communicated based on a time period associated with the first NES state, based on receiving a control message indicating that the first NES state is active, or both.

Another apparatus for wireless communication at a UE is described. The apparatus may include means for receiving, from a network entity, control signaling indicating a set of multiple NES states of the network entity and means for communicating one or more messages with the network entity in accordance with a first NES state of the set of multiple NES states, the one or more messages being communicated based on a time period associated with the first NES state, based on receiving a control message indicating that the first NES state is active, or both.

A non-transitory computer-readable medium storing code for wireless communication at a UE is described. The code may include instructions executable by a processor to receive, from a network entity, control signaling indicating a set of multiple NES states of the network entity and communicate one or more messages with the network entity in accordance with a first NES state of the set of multiple NES states, the one or more messages being communicated based on a time period associated with the first NES state, based on receiving a control message indicating that the first NES state is active, or both.

In some examples of the method, apparatuses, and non-transitory computer-readable medium described herein, communicating the one or more messages may include operations, features, means, or instructions for communicating the one or more messages with the network entity that may be operating in the first NES state based on a time pattern associated with the set of multiple NES states indicating that the network entity may be operating in the first NES state.

Some examples of the method, apparatuses, and non-transitory computer-readable medium described herein may further include operations, features, means, or instructions for receiving the control signaling indicating the time pattern associated with the set of multiple NES states.

In some examples of the method, apparatuses, and non-transitory computer-readable medium described herein, each time interval of a quantity of time intervals of the time pattern includes one or more symbols, one or more slots, one or more frames, one or more seconds, one or more milliseconds, one or more time periods, or any combination thereof.

In some examples of the method, apparatuses, and non-transitory computer-readable medium described herein, a duration of a respective time interval of a quantity of time intervals of the time pattern may be based on a subcarrier spacing of the time pattern.

In some examples of the method, apparatuses, and non-transitory computer-readable medium described herein, the set of multiple NES states include at least one of a baseline operating state, a reduced energy consumption state, a network support operation state, or a flexible operation state.

In some examples of the method, apparatuses, and non-transitory computer-readable medium described herein, communicating the one or more messages may include operations, features, means, or instructions for receiving the control signaling or the control message that indicates one or more communication parameters associated with the first NES state and communicating the one or more messages based on the one or more communication parameters that may be associated with the first NES state.

In some examples of the method, apparatuses, and non-transitory computer-readable medium described herein, and the method, apparatuses, and non-transitory computer-readable medium may include further operations, features, means, or instructions for receiving the control message that indicates an activated pattern of the set of multiple NES state patterns, where the first NES state may be identified based on the activated pattern.

In some examples of the method, apparatuses, and non-transitory computer-readable medium described herein, the activated pattern may be based on at least one of a network load, one or more capabilities of the UE, or one or more NES parameters, or any combination thereof.

Some examples of the method, apparatuses, and non-transitory computer-readable medium described herein may further include operations, features, means, or instructions for receiving the control message which indicates that the first NES state may be active by indicating a change in one or more channel state information reference signal (CSI-RS) reporting configuration parameters, a change in an indicated transmission power of the network entity, or a change in one or more dynamic grant configurations for the one or more messages, or any combination thereof.

Some examples of the method, apparatuses, and non-transitory computer-readable medium described herein may further include operations, features, means, or instructions for receiving the control message that indicates that the network entity may be operating in the first NES state, where the first NES state may be a flexible NES state or a default NES state.

Some examples of the method, apparatuses, and non-transitory computer-readable medium described herein may further include operations, features, means, or instructions for modifying one or more transmission and reception parameters based on the first NES state, the one or more transmission and reception parameters including at least one of one or more uplink power control parameters, one or more antenna rank parameters, or one or more modulation and coding scheme parameters, or any combination thereof, and where the one or more messages may be communicated based on the one or more transmission and reception parameters.

In some examples of the method, apparatuses, and non-transitory computer-readable medium described herein, communicating the one or more messages may include operations, features, means, or instructions for modifying one or more communication techniques performed by the UE based on the first NES state, the one or more communication techniques including at least one of one or more uplink skipping techniques, one or more scheduling request procedures, one or more beam failure detection and recovery techniques, or one or more random access channel procedures, or any combination thereof.

A method for wireless communication at a network entity is described. The method may include transmitting, to a UE, control signaling indicating a set of multiple NES states of the network entity, operating in a first NES state of the set of multiple NES states based on a time period being associated with the first NES state, or based on a control message indicating that the first NES state is active, and communicating, with the UE, one or more messages in accordance with the first NES state.

An apparatus for wireless communication at a network entity is described. The apparatus may include a processor, memory coupled with the processor, and instructions stored in the memory. The instructions may be executable by the processor to cause the apparatus to transmit, to a UE, control signaling indicating a set of multiple NES states of the network entity, operate in a first NES state of the set of multiple NES states based on a time period being associated with the first NES state, or based on a control message indicating that the first NES state is active, and communicate, with the UE, one or more messages in accordance with the first NES state.

Another apparatus for wireless communication at a network entity is described. The apparatus may include means for transmitting, to a UE, control signaling indicating a set of multiple NES states of the network entity, means for operating in a first NES state of the set of multiple NES states based on a time period being associated with the first NES state, or based on a control message indicating that the first NES state is active, and means for communicating, with the UE, one or more messages in accordance with the first NES state.

A non-transitory computer-readable medium storing code for wireless communication at a network entity is described. The code may include instructions executable by a processor to transmit, to a UE, control signaling indicating a set of multiple NES states of the network entity, operate in a first NES state of the set of multiple NES states based on a time period being associated with the first NES state, or based on a control message indicating that the first NES state is active, and communicate, with the UE, one or more messages in accordance with the first NES state.

In some examples of the method, apparatuses, and non-transitory computer-readable medium described herein, communicating the one or more messages may include operations, features, means, or instructions for communicating the one or more messages with the UE while operating in the first NES state based on a time pattern associated with the set of multiple NES states indicating that the network entity may be operating in the first NES state.

Some examples of the method, apparatuses, and non-transitory computer-readable medium described herein may further include operations, features, means, or instructions for transmitting the control signaling indicating the time pattern associated with the set of multiple NES states.

In some examples of the method, apparatuses, and non-transitory computer-readable medium described herein, each time interval of a quantity of time intervals of the time pattern includes one or more symbols, one or more slots, one or more frames, one or more seconds, one or more milliseconds, one or more time periods, or any combination thereof.

In some examples of the method, apparatuses, and non-transitory computer-readable medium described herein, a duration of a respective time interval of a quantity of time intervals of the time pattern may be based on a subcarrier spacing of the time pattern.

In some examples of the method, apparatuses, and non-transitory computer-readable medium described herein, the set of multiple NES states include at least one of a baseline operating state, a reduced energy consumption state, a network support operation state, or a flexible operation state.

In some examples of the method, apparatuses, and non-transitory computer-readable medium described herein, communicating the one or more messages may include operations, features, means, or instructions for transmitting the control signaling or the control message that indicates one or more communication parameters associated with the first NES state and communicating the one or more messages in accordance with the first NES state.

In some examples of the method, apparatuses, and non-transitory computer-readable medium described herein, and the method, apparatuses, and non-transitory computer-readable medium may include further operations, features, means, or instructions for transmitting the control message that indicates an activated pattern of the set of multiple NES state patterns and operating in the first NES state based on the activated pattern.

In some examples of the method, apparatuses, and non-transitory computer-readable medium described herein, the activated pattern may be based on at least one of a network load, one or more capabilities of the UE, or one or more NES parameters, or any combination thereof.

Some examples of the method, apparatuses, and non-transitory computer-readable medium described herein may further include operations, features, means, or instructions for transmitting the control message that indicates that the network entity that may be operating in the first NES state that may be a flexible NES state or a default NES state.

In some examples of the method, apparatuses, and non-transitory computer-readable medium described herein, switching, by the network entity, between two or more of the set of multiple NES states over time.

### BRIEF DESCRIPTION OF THE DRAWINGS

FIGS. 1 and 2 illustrate examples of wireless communications systems that support network operation time interval indication in accordance with one or more aspects of the present disclosure.

FIG. 3 illustrates an example of a network energy saving (NES) state timeline that supports network operation time interval indication in accordance with one or more aspects of the present disclosure.

FIG. 4 illustrates an example of a NES time sequence that supports network operation time interval indication in accordance with one or more aspects of the present disclosure.

FIG. 5 illustrates an example of a process flow that supports network operation time interval indication in accordance with one or more aspects of the present disclosure.

FIGS. 6 and 7 show block diagrams of devices that support network operation time interval indication in accordance with one or more aspects of the present disclosure.

FIG. 8 shows a block diagram of a communications manager that supports network operation time interval indication in accordance with one or more aspects of the present disclosure.

FIG. 9 shows a diagram of a system including a device that supports network operation time interval indication in accordance with one or more aspects of the present disclosure.

FIGS. 10 and 11 show block diagrams of devices that support network operation time interval indication in accordance with one or more aspects of the present disclosure.

FIG. 12 shows a block diagram of a communications manager that supports network operation time interval indication in accordance with one or more aspects of the present disclosure.

FIG. 13 shows a diagram of a system including a device that supports network operation time interval indication in accordance with one or more aspects of the present disclosure.

FIGS. 14 through 18 show flowcharts illustrating methods that support network operation time interval indication in accordance with one or more aspects of the present disclosure.

### DETAILED DESCRIPTION

In some wireless communication networks, a user equipment (UE) and a network entity may perform wireless communications in high traffic scenarios (e.g., communications associated with relatively high data rates, high code rates, etc.). In some examples, performing wireless communications in high traffic may result in a correspondingly high network power consumption. In order to decrease power consumption and increase power savings, a network entity may enter a network energy saving (NES) state based on the traffic level, which may result in a relative reduction in network power consumption. For example, the network may enter from a baseline or legacy NES state and transition to various different NES states based on the traffic level in the network. In some cases, the network may fix a pattern of NES states and may operate in accordance with the pattern. In addition, the UE may implement different states of operation to accommodate the NES states that the network is operating in. In some cases, however, the UE may not be aware of the network transition between NES states, which may reduce coordination between devices, and may reduce potential energy savings.

The features described herein generally relate to a NES state time indication to decrease energy consumption by enabling a network entity to indicate an NES state to a UE. In some examples, a UE may receive control signaling from a network entity, and the control signaling may indicate multiple NES states of the network entity. The UE and the network entity may communicate one or more messages in accordance with a first NES state of the multiple NES states. The one or more messages that are communicated may be based on a time period associated with the first NES state, based on receiving a control message indicating that the first NES state is active, or both.

Once the UE is configured with the one or more NES states, the UE may effectively be able to adapt its own signaling (e.g., the UE may modify transmission and reception parameters, communication techniques to communicate with the network entity, or both) to accommodate the different NES states of the network. In such examples, the coordination between the UE and the network may reduce power expenditure and increase associated power savings between both the UE and the network. Additionally, or alternatively, the techniques described herein may increase coordination between devices, as the UE may be configured (or preconfigured) with information regarding different energy states of the network.

In some other examples, the control signaling may indicate a time pattern associated with the multiple NES states. For example, the UE may be configured with a time sequence of NES states to allocate time intervals for an increased NES state (e.g., baseline NES state) in high traffic level scenarios, a reduced NES state in relatively lower traffic level scenarios, a network, a network support operation state, or a flexible NES state. In this example, the network entity may dynamically adapt the time sequence of the flexible NES state. Additionally or alternatively, the control signaling may include a control message that indicates some NES state is active. For example, the UE may be explicitly configured by the network entity (e.g., via radio resource control (RRC) signaling, medium access control-control element (MAC-CE), or downlink control information (DCI)) with an indication of the NES state. Based on the NES state signaled to the UE, the UE may modify transmission and reception parameters, communication techniques, or both to communicate with the network entity.

In accordance with supporting a NES state time indication, a network entity may indicate multiple NES states of the network entity, such as the various NES states described herein, which may facilitate efficient communication between the UE and the network entity. The UE and the network entity may communicate one or more messages via control signaling which indicates an activated NES state of the network entity. In other words, the UE and the network entity may establish reliable communication for more efficient energy use in accordance with control signaling that indicates a time period associated with a NES state, a control message indicating that the first NES state is activated, or both. Such lower energy consumption and increased efficiency may further support higher data rates, greater system capacity, and decreased latency, among other benefits. Further, to facilitate decreased energy consumption in communications, the UE and the network entity may support communicating the one or more messages based on a time pattern associated with the multiple NES states. The time pattern may be transmitted by the network entity to the UE. In some examples, the control message may implicitly indicate the NES state (e.g., by a change in one or more channel state information-reference signal (CSI-RS) parameters, a change in transmission power of the network entity, a change in dynamic grant configurations, or a combination thereof). In some examples, the UE may modify transmission and reception parameters, communication techniques to communicate the one or more messages to the network entity, or both based on the activated NES state.

Additionally or alternatively, such implementations of the subject matter described in this disclosure also can be implemented to realize one or more of the following potential advantages. For example, in accordance with supporting communication of the one or more messages based on a time pattern associated with the multiple NES states, the UE and the network entity may reduce or eliminate activation or deactivation ambiguity of the NES state while maintaining relatively low latency. Moreover, in implementations in which the network entity implicitly indicates the NES state, or the UE modifies transmission and reception parameters, communication techniques, or both, the implementations may be beneficial in various deployment scenarios, including in energy conservation scenarios. Such lower latency, reduced ambiguity, and implicit NES state indications may further support higher data rates, greater system capacity, and decreased latency, among other benefits.

Aspects of the disclosure are initially described in the context of wireless communications systems. Aspects of the disclosure are further illustrated and described by a sleep state timeline, an NES state time sequence, and a process flow. Aspects of the disclosure are further illustrated by and described with reference to apparatus diagrams, system diagrams, and flowcharts that relate to network operation time interval indication.

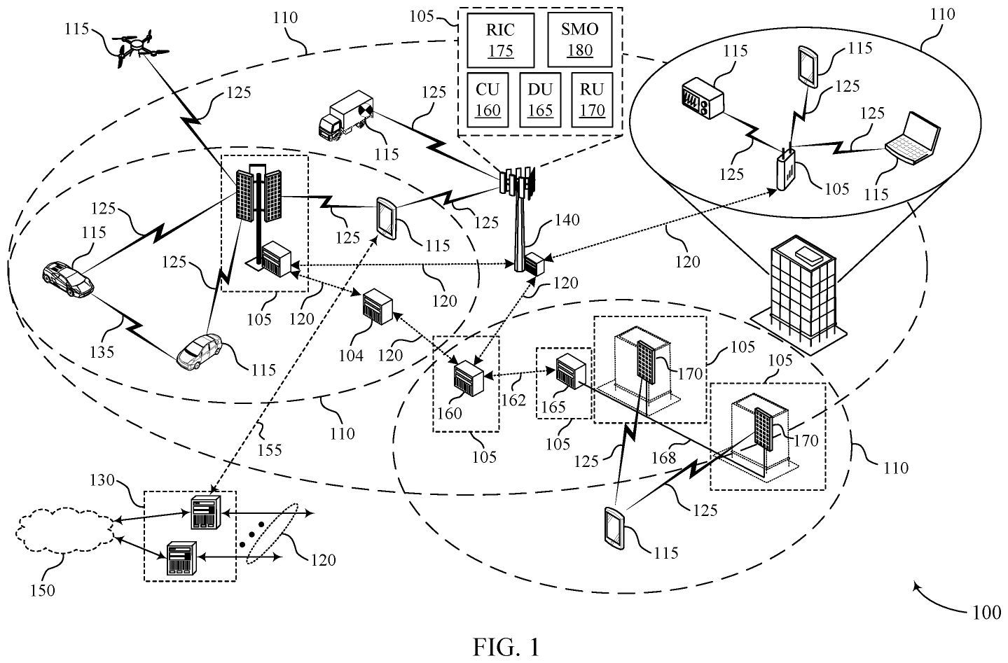

FIG. 1 illustrates an example of a wireless communications system 100 that supports network operation time interval indication in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or ore radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support network operation time interval indication as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/Δfₘₐₓ·N_{f} seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some wireless communications networks, a UE 115 and a network entity 105 may consume a certain amount of energy to communicate within a radio access network (RAN). For example, in a network entity energy consumption model, the total energy consumption may be based on a relative energy consumption for downlink and uplink transmissions, sleep states associated with the network entity 105, associated transition times of the sleep states, and one or more reference parameters or configurations. The total energy consumption may be further based on factors such as power added (PA) efficiency, number of transmission radio units (TxRUs), and the network entity load of a network entity 105. In this example, communications within a cellular network (e.g., a high traffic scenario) may be associated with a high cost of network energy consumption (e.g., 23% of total cost). The network energy consumption may be evaluated based on assessing network entity and UE communications (e.g., spectral efficiency, capacity, user perceived throughput (UPT), latency, handover performance, call drop rate, initial access performance, service level agreement (SLA) assurance related key performance indicator (KPIs), etc.), energy efficiency, and UE power consumption. For example, multiple KPIs may be evaluated for a network. In this case, performing communications within RAN uses a majority of the network energy consumption (e.g., running a 5G network uses up around 50% of the network energy). The high cost of network energy consumption associated with the RAN may result in increased latency in communications and may result in an inability to expand cellular networks.

In some examples, the UE 115 and the network entity 105 may implement NES techniques in order to save power and maintain network operations. For example, the network entity 105 may enter different sleep states based on the current traffic level (or future predicted traffic levels) in a network 110. Transitioning from a light sleep state to a baseline state may take a relatively longer amount of time than transitioning from a deep sleep state to the baseline state. Additionally or alternatively, the network entity 105 may disable the TxRUs of the network entity 105 to save power. However, transitioning across sleep states and disabling the TxRUs may be associated with a large transition time, which may further consume power and may increase latency. Additionally, the UE 115 may not be aware of the sleep state of the network entity 105, which may further increase latency.

In order to alleviate the power consumption associated with the transition times, the network entity 105 may select states of operation based on future data traffic (e.g., the network 105 may plan ahead and predict the future traffic). However, the network entity 105 may not be able to predict future traffic efficiently and accurately, which may result in increased inefficiency and in further latency. In a similar case, such as time division duplex (TDD) configuration techniques for transmissions, a network entity 105 may configure some duplex slots as downlink slots, uplink slots, or flexible slots. For example, the network entity 105 may statically configure a relatively greater quantity of slots as downlink slots if downlink traffic is relatively higher, and the network entity 105 may configure a relatively greater quantity of slots as uplink slots if uplink traffic is relatively higher. The network entity 105 may dynamically indicate (e.g., adapt) the flexible slots to be uplink slots or downlink slots based on the traffic (e.g., based on an optimization by the network entity 105). However, the dynamic and static slot indication in TDD configuration may not be currently implemented in NES techniques.

Wireless communications system 100 may support NES state time indication to decrease network energy consumption. In some examples, a UE 115 may receive control signaling from a network entity 105, and the control signaling may indicate multiple NES states that correspond to different NES states of the network entity 105. For example, a NES state may correspond to or be indicative of a number of power reduction NES states, or various other NES states described herein.

In one example, the control signaling may indicate a time pattern associated with the multiple NES states. For example, the UE 115 may be configured with a time sequence of NES states (e.g., similar to the TDD configuration) to allocate time intervals for NES states in high traffic level scenarios and other NES states in relatively lower traffic level scenarios. The NES states may include a baseline (e.g., legacy) NES state, a reduced energy consumption state, a network support operation state, or a flexible NES state (e.g., flexible operation state). In this example, the time sequence of network operation may be based on a granularity (e.g., granularity of symbols, slots, frames, seconds, or sub-carrier spacing). Additionally or alternatively, the control signaling may include a control message that indicates a NES state is active for the network entity 105. For example, the UE 115 may be explicitly configured by the network entity 105 (e.g., via RRC signaling, MAC-CE, or DCI) with an indication of the NES state. Based on the NES state signaled to the UE 115, the UE 115 may modify transmission and reception parameters, communication techniques, or both to communicate with the network entity 105.

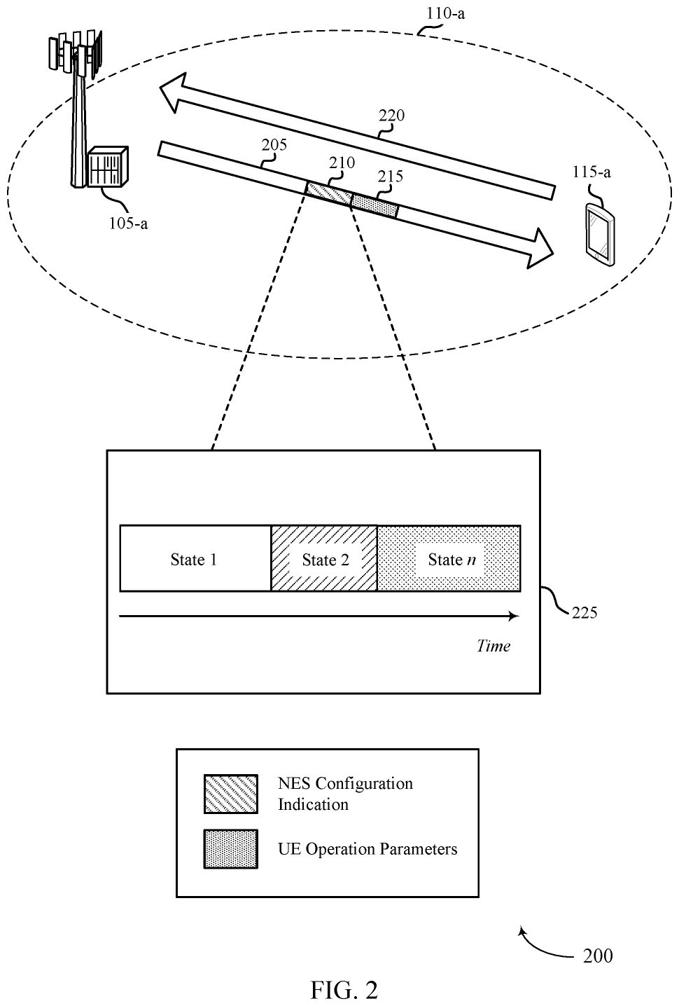

FIG. 2 illustrates an example of a wireless communications system 200 that supports network operation time interval indication in accordance with one or more aspects of the present disclosure. In some examples, wireless communications system 200 may implement aspects of wireless communications system 100. For example, wireless communications system 200 may support communications between a network entity 105-a and UE 115-a, which may be examples of corresponding network entities 105 and UEs 115 as described with reference to FIG. 1. In some examples, network entity 105-a may communicate with one or more UEs 115 within geographic coverage area 110-a.

Network entity 105-a may send downlink transmissions to UE 115-a over downlink communication link 205 and the UE 115-a may correspondingly send uplink transmissions to network entity 105-a over uplink communication link 220. In some examples, the network entity 105-a and the UE 115-a may support NES techniques to conserve energy (e.g., from the perspective of the network, the UE 115-a, or both), increase coordination between devices, and to increase energy savings over time. The network entity 105-a may configure the UE 115-a with different NES states of operation (e.g., state 1, state 2, through state n, at 225) indicated to the UE, such that the UE 115-a may identify during which time intervals the network entity 105-a is to implement different NES states. In some examples, the different NES states or energy saving states may include a baseline NES, an reduced energy consumption state, a network support operation state, or a flexible NES state. For example, the network entity 105-a may transmit control signaling to the UE 115-a via downlink communication link 205. The control signaling may include a network operation configuration indication 210 and UE operation parameters 215. The network operation configuration indication 210 may indicate a time sequence 225 of NES states of the network entity 105-a of the multiple NES states. The time sequence of the NES states may include time intervals, where the time intervals are one or more symbols, one or more slots, one or more frames, one or more seconds, one or more milliseconds, or one or more time periods. In some examples, the duration of the time intervals may be based on a subcarrier spacing of the time sequence. Additionally or alternatively, the network operation configuration indication 210 may include a control message, which may indicate that a first NES state is active.

Additionally or alternatively, the UE operation parameters 215 may implicitly or explicitly indicate an actual (e.g., exact) NES state for a flexible NES state. For example, the UE operation parameters 215 may implicitly indicate the actual NES state (e.g., baseline NES, reduced energy consumption state, or network support operation state) via one or more of CSI-RS report, a change in transmission power of the network entity 105-a, or a change in one or more dynamic grant configurations for transmissions and receptions. In another example, the UE operation parameters 215 may explicitly indicate the actual NES state via RRC reconfiguration, a MAC-CE, or DCI (e.g., a physical downlink shared channel (PDSCH)/physical uplink shared channel (PUSCH) scheduling the DCI with the indication of the actual NES state using extra bits). Additionally or alternatively, if the network entity 105-a refrains from indicating the actual NES state (e.g., the network entity 105-a refrains from transmitting the UE operation parameters 215) the UE 115-a may assume (e.g., communicate using) the baseline state, or the UE 115-a may communicate using an RRC configured default network operation.

Based on the network operation configuration indication 210 and the UE operation parameters 215, the UE 115-a may modify or adjust transmission and reception parameters to communicate with the network entity 105-a based on the different NES states. The transmission and reception parameters may include one or more of uplink power control parameters, antenna rank parameters, or modulation and coding scheme parameters. Additionally or alternatively, the UE 115-a may modify techniques to communicate with the network entity 105-a based on the first NES state. The techniques may include one or more of uplink skipping techniques, scheduling request procedures, beam failure detection and recovery techniques, or random access channel (RACH) occasion procedures. The UE 115-a may then communicate with the network entity 105-a via the uplink communication link 220 based on the modifications and the control signaling from the network entity 105-a.

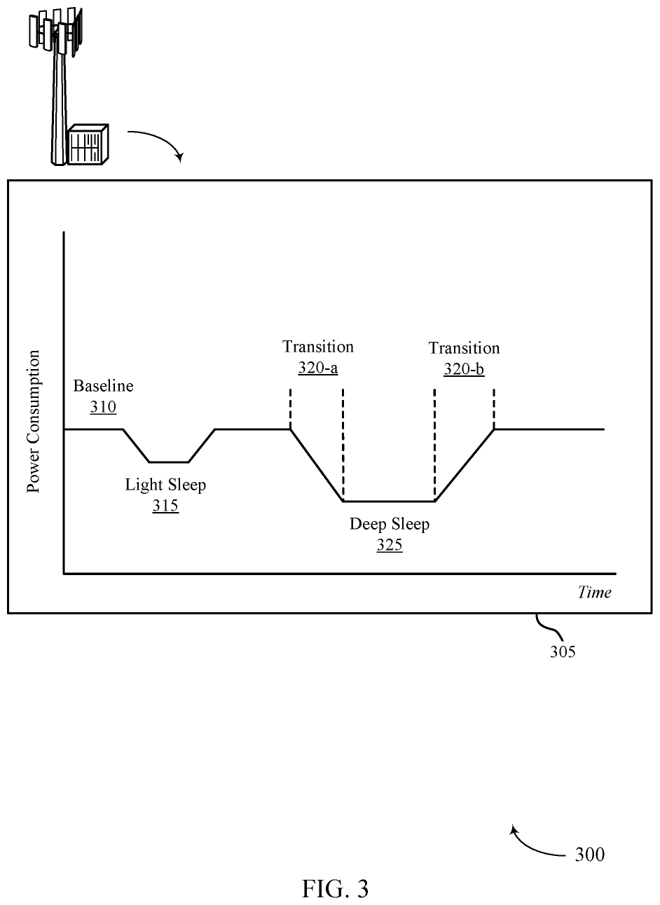

FIG. 3 illustrates an example of a NES state timeline 300 that supports network operation time interval indication in accordance with one or more aspects of the present disclosure. The NES state timeline 300 illustrates aspects of techniques performed by a network entity 105 and a UE 115, which may be examples of a network entity 105 and a UE 115 as described with reference to FIGS. 1 and 2. For example, the network entity 105 may indicate various NES states to the UE 115, and the UE 115 may adjust its operation based on the indicated NES states.

In some examples, the UE 115 and the network entity 105 may implement NES techniques to save power and maintain network operations while supporting efficient use of high power and low power states. For example, the network entity 105 may enter different sleep states based on the traffic level in a network 110. The sleep states may include a baseline sleep state 310 (e.g., legacy operation), a light sleep state 315, and a deep sleep state 325. The network entity 105 may also transition between different NES states via transition states 320-a and 320-b. In NES state timeline 305, the sleep states may be different in terms of operation (e.g., some sleep or NES states may be associated with disabling or turning off radio frequency (RF) communication chains, while some other NES states will leave RF communication chains active).

Additionally, in some cases the different NES states that correspond to different NES states may be associated with a different power consumption levels and may have different transition times based on the relative differences in power consumption. For example, the baseline state may be associated with a relatively higher level of power consumption than the light sleep state or the deep sleep state. The light sleep state may be associated with a higher level of power consumption than the deep sleep state. Additionally or alternatively, the network entity 105 may transition from one sleep state to another sleep state. Transitioning from a light sleep state to the baseline state may take a relatively longer amount of time than transitioning from a deep sleep state to the baseline state, as shown in NES state timeline 305. However, transitioning across sleep states and may be associated with a large transition time, which may further consume power and may increase latency.

In some examples, the UE may be configured (e.g., explicitly or implicitly) with an indication of a time sequence of network operations, such as the NES state timeline 305 which indicates a pattern (or a schedule) of network operations including the time intervals (e.g., symbols, slots, frames, seconds, or sub-carrier spacing) in which the network will be operating in different power consumption states or sleep states. For example, the UE may receive a network operation time interval indication (e.g., illustrated in FIG. 2), which may notify the UE of various changes in network operation performed by network entity 105. In some examples, the UE may adapt its communications based on the NES states indicated by the pattern. For example, the UE may adapt its own uplink power control, modulation and coding scheme, uplink skipping, beam failure detection, among other processes based on the network pattern.

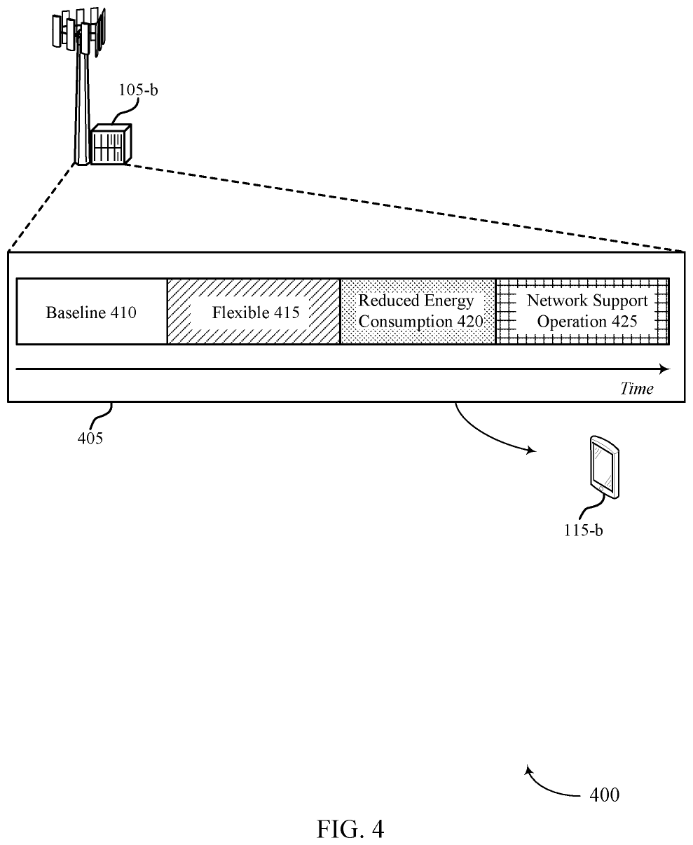

FIG. 4 illustrates an example of a NES time sequence 400 that supports network operation time interval indication in accordance with one or more aspects of the present disclosure. NES time sequence 400 illustrates aspects of techniques performed by a network entity 105-b and a UE 115-b, which may be examples of a network entity 105 and a UE 115 as described with reference to FIGS. 1 and 2.

In some examples, the network entity 105-b and the UE 115-b may perform NES techniques to conserve energy (e.g., from both the perspective of the network entity 105-b and from the perspective of the UE 115-b) and to increase the quality and efficiency of communications. The network entity 105-b may configure the UE 115-b with different NES states of operations that the network uses to operate during various time intervals. For example, the UE 115-b may be configured (e.g., by the network entity 105-b) with a time sequence of NES states 405 in terms of symbols, slots, frames, milliseconds, seconds, or any other time duration. In some other examples, the granularity of the configured time sequence may depend on the subcarrier spacing of the communications.

In some aspects, the different NES states 405 may include a baseline operating state (e.g., baseline operation 410, which may support one or more legacy operations), a reduced energy consumption state (e.g., reduced energy consumption state 420), a network support operation state (e.g., network support operation state 425), or a flexible NES state (e.g., flexible NES state 415). The reduced energy consumption state may be a generic reduced energy consumption state or different reduced energy consumption predefined or configured states (NES1, NES2, etc.). The network support operation state 425 may be a state in which the network entity 105-b may increase the capability or coverage of the network entity 105-b to increase the capability of the network overall (e.g., other network entities 105-b may be in a reduced power consumption state, and the network entity 105-b may increase coverage to decrease latency). The flexible NES state may be a state in which the operation of the network entity 105-b may not be specified (e.g., for a given time duration) and may be implicitly or dynamically indicated.

For example, the network entity 105-b may transmit control signaling to the UE 115-b via a downlink communication link. The control signaling may indicate a time sequence of NES states of the network entity 105-b of the multiple NES states. Table 1, shown below, shown an example of a pattern of NES states that the network entity 105-b may transmit to or configure for the UE 115-b.

TABLE 1
Example of a Pattern of NES states

| | | | | | | | | | | |
|---|---|---|---|---|---|---|---|---|---|---|
| Pattern 0 | L | L | L | L | F | NES1 | NES1 | L | L | L |
| Pattern 1 | L | L | L | NES2 | NES2 | L | L | NES1 | NES1 | NES1 |
| Pattern 2 | L | L | F | F | F | F | F | F | L | L |
| Pattern 3 | L | L | NES1 | NES1 | NES1 | NES2 | NES2 | NES2 | F | F |
| Pattern 4 | F | F | F | F | F | F | F | F | F | F |

In an example, each of the slots may be associated with a NES state and a time period. The legacy slots (e.g., L), the NES1 slots, and the NES2 slots may be associated with fixed patterns of network operations configured to the UE 115-b (e.g., RRC configured). The fixed patterns may be activated (e.g., the UE 115-b may communicate with the network entity 105-b based on the patterns) at a time interval associated with the pattern. In some examples, the control signaling may include a bit field that includes an index value, where the index value may indicate which of the patterns is activated (e.g., with a 0 or 1 bit value in the bit field). Examples of patterns may include all legacy operations (e.g., all of the slots are L), or all flexible operation pattern (e.g., all of the slots are F). In this example, the NES1 may correspond to 32 ports for communication at the network entity 105-b, and the NES2 may correspond to 16 ports for communication at the network entity 105-b (e.g., NES1 may implement a greater number of antenna ports relative to NES2).

For flexible NES state 415, the network entity 105-b may implicitly or explicitly indicate an actual (e.g., exact) NES state for the flexible NES state, and the UE 115-b may determine the operation state either implicitly, via a dynamic indication or using a defined default behavior of the UE. In some examples, the or more NES states or patterns may be associated with one or more of types of CSI-RS reports or with one or more different transmission powers of the network entity 105-b (e.g., if CSI configuration changes to a different number of ports). In some other examples, the one or more NES states or patterns may be associated with a change in one or more dynamic grant configurations for transmissions and receptions. In such examples, the network entity may configure the UE 115-b with a CSI-RS report, a transmission power or a dynamic grant configuration, and the UE 115-b may implicitly determine which NES state or pattern corresponds to a configured CSI-RS, transmission power, or dynamic grant. In some other examples, explicit indication of the NES state or pattern may be configured RRC reconfiguration, MAC-CE, or DCI (e.g., a physical downlink shared channel (PDSCH)/physical uplink shared channel (PUSCH) scheduling the DCI with the indication of the actual NES state using extra bits). In some other examples, the UE 115-b may implement default behavior in cases that the NES state is not indicated for the flexible operation state 415. For example, the UE 115-b may implement a baseline operation 410, or may implement a default RRC configured network operation.

In some examples, the network entity 105-b may select a NES state or pattern based on various factors such as network load, UE capabilities, or a combination thereof, and indicate, either implicitly or explicitly, the NES state or pattern to the UE 105.b. Based on the time sequence and on the control message indicating the first NES state, the UE 115-b may communicate with the network entity 105-b in accordance with the different network energy operation states.

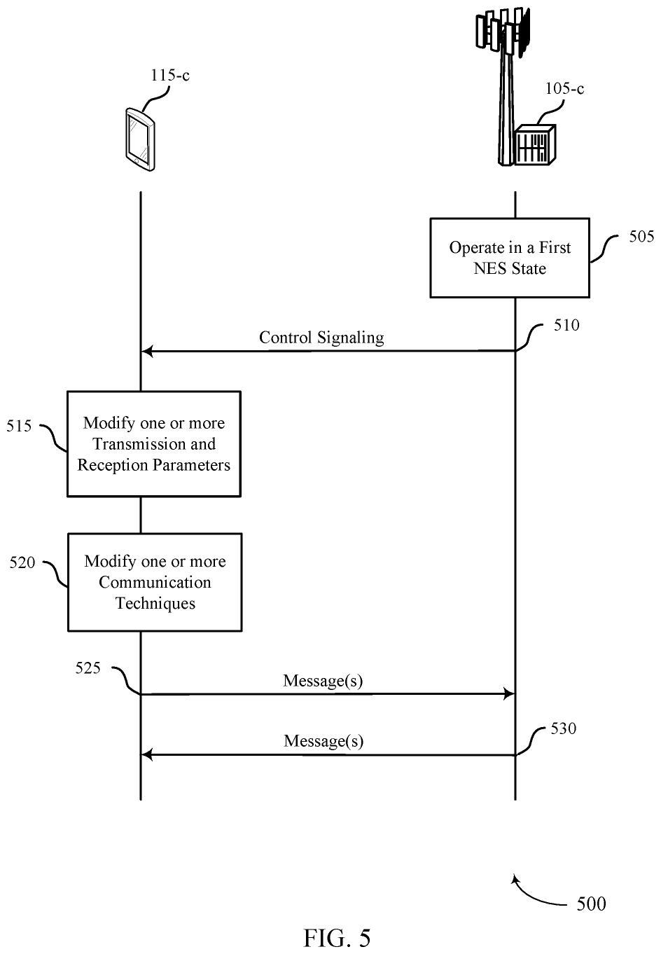

FIG. 5 illustrates an example of a process flow 500 that supports network operation time interval indication in accordance with one or more aspects of the present disclosure. In some examples, process flow 500 may implement aspects of wireless communications systems 100 and 200. Process flow 500 illustrates aspects of techniques performed by a network entity 105-c and a UE 115-c, which may be examples of a network entity 105 and a UE 115 as described with reference to FIGS. 1-4.

In the following description of the process flow 500, the operations between the UE 115-c and network entity 105-c may be performed in different orders or at different times. Certain operations may also be left out of the process flow 500, or other operations may be added to the process flow 500.

At 505, the network entity 105-c may operate in a first NES state of multiple NES states based on a time period associated with the first NES state or based on transmitting a control message to the UE 115-c indicating that the first NES state is active. In some examples, the multiple NES states may correspond to a number of different NES states. For example, a NES state may correspond to or be indicative of a number of power saving NES states, or various other NES states described herein.

At 510, the network entity 105-c may transmit control signaling to the UE 115-c indicating the multiple NES states of the network entity 105-c. The control signaling may indicate a time pattern associated with the multiple NES states. Each time interval of a quantity of time intervals of the time pattern may include one or more symbols, one or more slots, one or more frames, one or more seconds, one or more milliseconds, one or more time periods, or a combination thereof. A duration of a respective time interval of the quantity of time intervals of the time pattern may be based on a subcarrier spacing of the time pattern. In some examples, the UE 115-c may communicate the one or more messages with the network entity that is operating in the first NES state based on a time pattern associated with the multiple energy saving states. For example, each time interval may be associated with an NES state, such that the UE 115-c may operate in the NES state at the time interval included in the time pattern. In some examples, the network entity may identify different amounts of traffic associated with different time intervals of the time pattern, and may apply different NES states during the different time intervals based on network traffic.

In some examples, the control signaling may indicate one or more NES states of the multiple NES states. The one or more NES states of the multiple NES states may correspond to or be indicative of one or more NES states, including at least one of a baseline NES, a reduced power consumption state, a network support operation state, or a flexible operation state. In some examples, the control signaling or the control message may indicate one or more communication parameters associated with the first NES. In some examples, the control signaling may indicate multiple NES state patterns (e.g., time patterns corresponding to NES states, where the NES states are based on time intervals included in the time patterns), and the first NES state may be identified based on an activated pattern of multiple NES state patterns. The activated pattern may be based on one or more of a network load, one or more capabilities of the UE 115-c, or one or more NES parameters.

In some examples, the control signaling or the control message may indicate one or more communication parameters associated with the first NES. In some examples, the control message may indicate that the first NES state is active by indicating one or more of a change in one or more CSI-RS reporting configuration parameters, a change in an indicated transmission power of the network entity 105-c, or a change in one or more dynamic grant configurations for the one or more messages. In some examples, the first NES state may be a flexible NES state or a default NES state.

At 515, the UE 115-c may modify one or more transmission and reception parameters based on the first NES state. For example, the UE 115-c may modify one or more transmission and reception parameters based on the controlling signaling indicating the first NES state and/or that the network entity 105-c is operating in the first NES state. The one or more transmission and reception parameters may include one or more uplink control parameters, one or more antenna rank parameters, one or more modulation and coding scheme parameters, or a combination thereof.

At 520, the UE 115-c may modify one or more communication techniques performed by the UE 115-c to communicate the one or more messages with the network entity 105-c based on the first NES state. For example, the UE 115-c may modify one or more communication techniques performed by the UE 115-c to communicate the one or more messages with the network entity 105-c based on the controlling signaling indicating the first NES state and/or that the network entity 105-c is operating in the first NES state. The one or more communication techniques may include one or more uplink skipping techniques, one or more scheduling request procedures, one or more beam failure detection and recovery techniques, one or more random access channel procedures, or a combination thereof.

For example, the UE 115-c may perform an uplink skipping technique by skipping (e.g., refraining from transmitting) an uplink transmission based on an uplink data buffer of the UE 115-c being empty. The UE 115-c may perform one or more scheduling request procedures by transmitting a scheduling request to the network entity 105-c to perform a transmission, and the network entity 105-c may indicate a set of resources for the UE 115-c to perform the transmission in response to the scheduling request. The UE 115-c may perform one or more beam failure detection and recovery techniques by measuring a beam metric associated with a beam, determining that the beam metric may be relatively low compared to other beams, and selecting another beam for communications. The UE 115-c may perform one or more random access channel (RACH) procedures by performing a two-step RACH procedure, a four-step RACH procedure, or a combination thereof. The RACH procedures may include uplink and downlink transmissions from the UE 115-c and the network entity 105-c for the UE 115-c to gain access to a channel.

At 525, the network entity 105-c and the UE 115-c may communicate one or more messages based on the first NES state of the multiple NES states. In some examples, the one or more messages may be included in the one or more communication techniques (e.g., the one or more communications techniques modified at 520). The one or more messages may be based on a time period associated with the first NES state, on receiving a control message that the first NES state is active, or both. For example, the one or more messages may be communicated by the UE 115-c during a time period of the time pattern that may be associated with an NES state.

In addition, the one or more messages may be communicated based on the one or more transmission and reception parameters. For example, the UE 115-c may receive an indication of the transmission and reception parameters, and the transmission and reception parameters may indicate the NES state of the UE 115-c during the communications, the transmission power of the communications, or a combination thereof. In some examples, the UE 115-c may receive the indication of the transmission and reception parameters via a CSI-RS report, dynamic grant configurations for transmissions and receptions, or a combination thereof. In some examples, the UE 115-c may communicate the one or more messages with the network entity that is operating in the first NES state based on a time pattern associated with the multiple energy saving states indicating that the network entity may be operating in the first NES state. In some examples, the network entity 105-c and the UE 115-c may communicate the one or more message based at least in part on the one or more communication parameters associated with the first NES state.

At 530, the network entity 105-c may communicate one or more messages with the UE 115-c in accordance with the first NES.

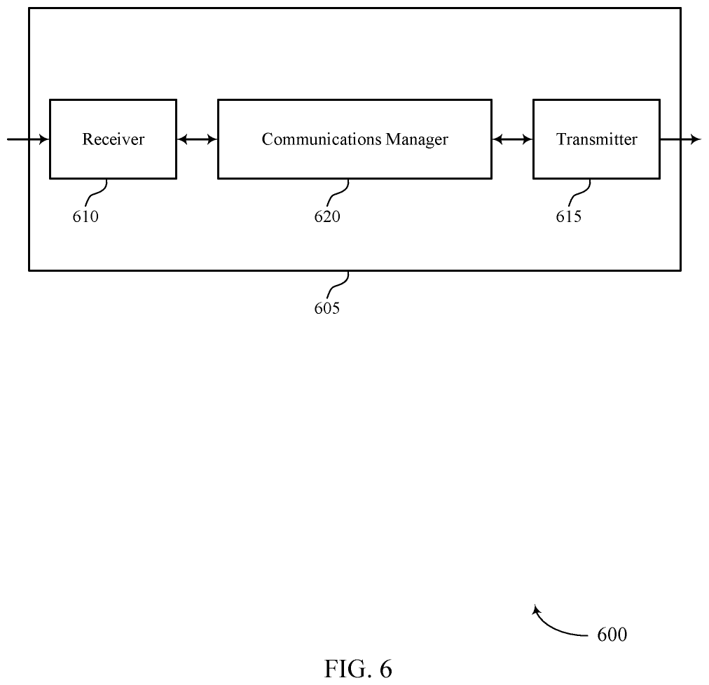

FIG. 6 shows a block diagram 600 of a device 605 that supports network operation time interval indication in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to network operation time interval indication). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to network operation time interval indication). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of network operation time interval indication as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. For example, the communications manager 620 may be configured as or otherwise support a means for receiving, from a network entity, control signaling indicating a set of multiple NES states of the network entity. The communications manager 620 may be configured as or otherwise support a means for communicating one or more messages with the network entity in accordance with a first NES state of the set of multiple NES states, the one or more messages being communicated based on a time period associated with the first NES state, based on receiving a control message indicating that the first NES state is active, or both.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reduced power consumption and more efficient utilization of communication resources.

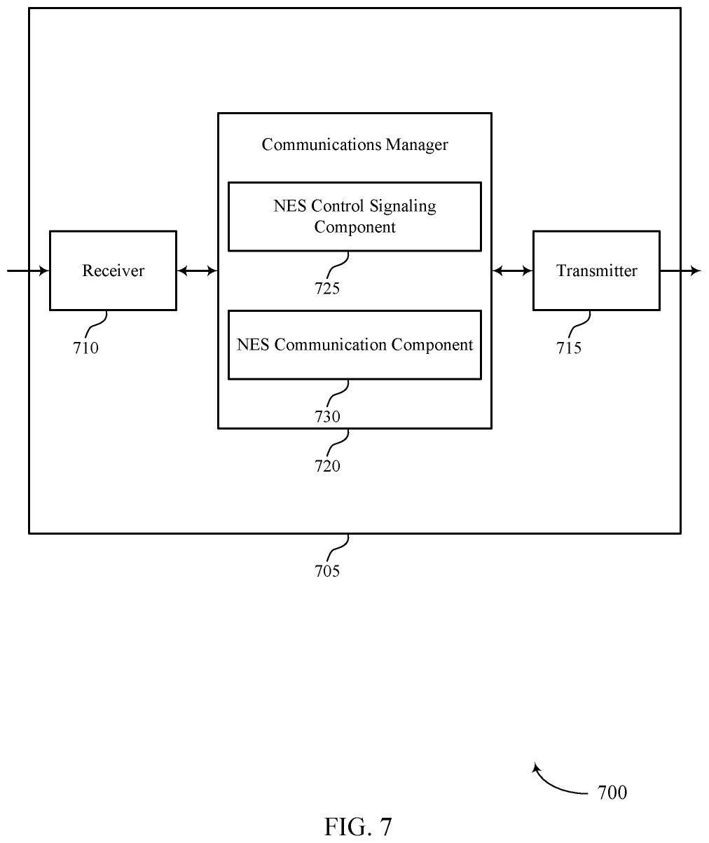

FIG. 7 shows a block diagram 700 of a device 705 that supports network operation time interval indication in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to network operation time interval indication). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to network operation time interval indication). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of network operation time interval indication as described herein. For example, the communications manager 720 may include an NES control signaling component 725 an NES communication component 730, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. The NES control signaling component 725 may be configured as or otherwise support a means for receiving, from a network entity, control signaling indicating a set of multiple NES states of the network entity. The NES communication component 730 may be configured as or otherwise support a means for communicating one or more messages with the network entity in accordance with a first NES state of the set of multiple NES states, the one or more messages being communicated based on a time period associated with the first NES state, based on receiving a control message indicating that the first NES state is active, or both.

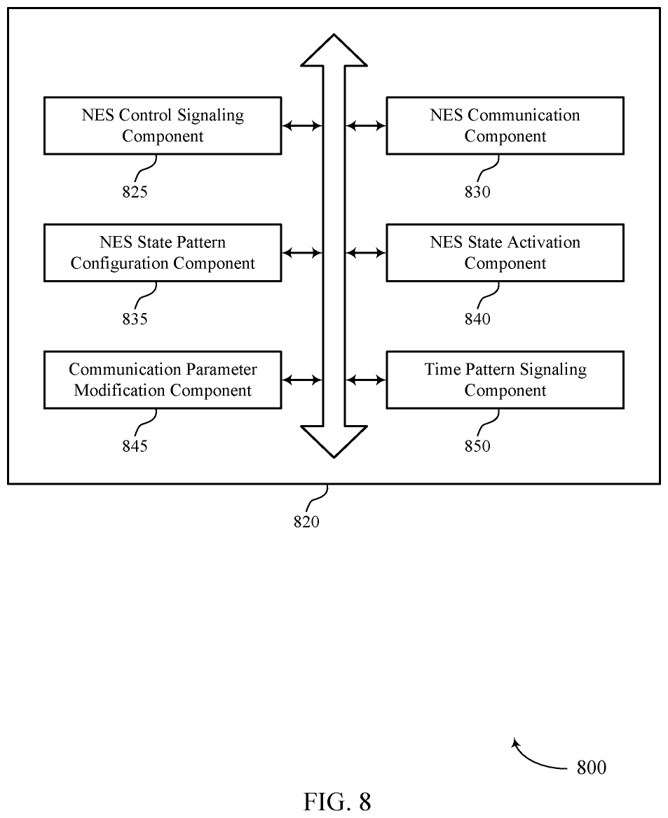

FIG. 8 shows a block diagram 800 of a communications manager 820 that supports network operation time interval indication in accordance with one or more aspects of the present disclosure. The communications manager 820 may be an example of aspects of a communications manager 620, a communications manager 720, or both, as described herein. The communications manager 820, or various components thereof, may be an example of means for performing various aspects of network operation time interval indication as described herein. For example, the communications manager 820 may include an NES control signaling component 825, an NES communication component 830, an NES state pattern configuration component 835, an NES state activation component 840, a communication parameter modification component 845, a time pattern signaling component 850, or any combination thereof. Each of these components may communicate, directly or indirectly, with one another (e.g., via one or more buses).

The communications manager 820 may support wireless communication at a UE in accordance with examples as disclosed herein. The NES control signaling component 825 may be configured as or otherwise support a means for receiving, from a network entity, control signaling indicating a set of multiple NES states of the network entity. The NES communication component 830 may be configured as or otherwise support a means for communicating one or more messages with the network entity in accordance with a first NES state of the set of multiple NES states, the one or more messages being communicated based on a time period associated with the first NES state, based on receiving a control message indicating that the first NES state is active, or both.

In some examples, to support communicating the one or more messages, the NES communication component 830 may be configured as or otherwise support a means for communicating the one or more messages with the network entity that is operating in the first NES state based on a time pattern associated with the set of multiple NES states indicating that the network entity is operating in the first NES state.

In some examples, the time pattern signaling component 850 may be configured as or otherwise support a means for receiving the control signaling indicating the time pattern associated with the set of multiple NES states.

In some examples, each time interval of a quantity of time intervals of the time pattern includes one or more symbols, one or more slots, one or more frames, one or more seconds, one or more milliseconds, one or more time periods, or any combination thereof.

In some examples, a duration of a respective time interval of a quantity of time intervals of the time pattern is based on a subcarrier spacing of the time pattern.

In some examples, the NES control signaling component 825 may be configured as or otherwise support the set of multiple NES states including at least one of a baseline operating state, a reduced energy consumption state, a network support operation state, or a flexible operation state.

In some examples, to support communicating the one or more messages, the NES control signaling component 825 may be configured as or otherwise support a means for communicating the one or more messages based on the one or more communication parameters that are associated with the first NES state.

In some examples, the control signaling indicates a plurality of NES state patterns and the NES state pattern configuration component 835 may be configured as or otherwise support a means for receiving the control message that indicates an activated pattern of the set of multiple NES state patterns, where the first NES state is identified based on the activated pattern.

In some examples, the activated pattern is based on at least one of a network load, one or more capabilities of the UE, or one or more NES parameters, or any combination thereof.

In some examples, the NES state activation component 840 may be configured as or otherwise support a means for receiving the control message which indicates that the first NES state is active by indicating a change in one or more channel state information reference signal (CSI-RS) reporting configuration parameters, a change in an indicated transmission power of the network entity, or a change in one or more dynamic grant configurations for the one or more messages, or any combination thereof.

In some examples, the NES state activation component 840 may be configured as or otherwise support a means for receiving the control message that indicates that the network entity is operating in the first NES state, where the first NES state is a flexible NES state or a default NES state.

In some examples, the communication parameter modification component 845 may be configured as or otherwise support a means for modifying one or more transmission and reception parameters based on the first NES state, the one or more transmission and reception parameters including at least one of one or more uplink power control parameters, one or more antenna rank parameters, or one or more modulation and coding scheme parameters, or any combination thereof, and where the one or more messages are communicated based on the one or more transmission and reception parameters.

In some examples, to support communicating the one or more messages, the NES communication component 830 may be configured as or otherwise support a means for modifying one or more communication techniques performed by the UE c to communicate the one or more messages with the network entity based on the first NES state, the one or more communication techniques including at least one of one or more uplink skipping techniques, one or more scheduling request procedures, one or more beam failure detection and recovery techniques, or one or more random access channel procedures, or any combination thereof.

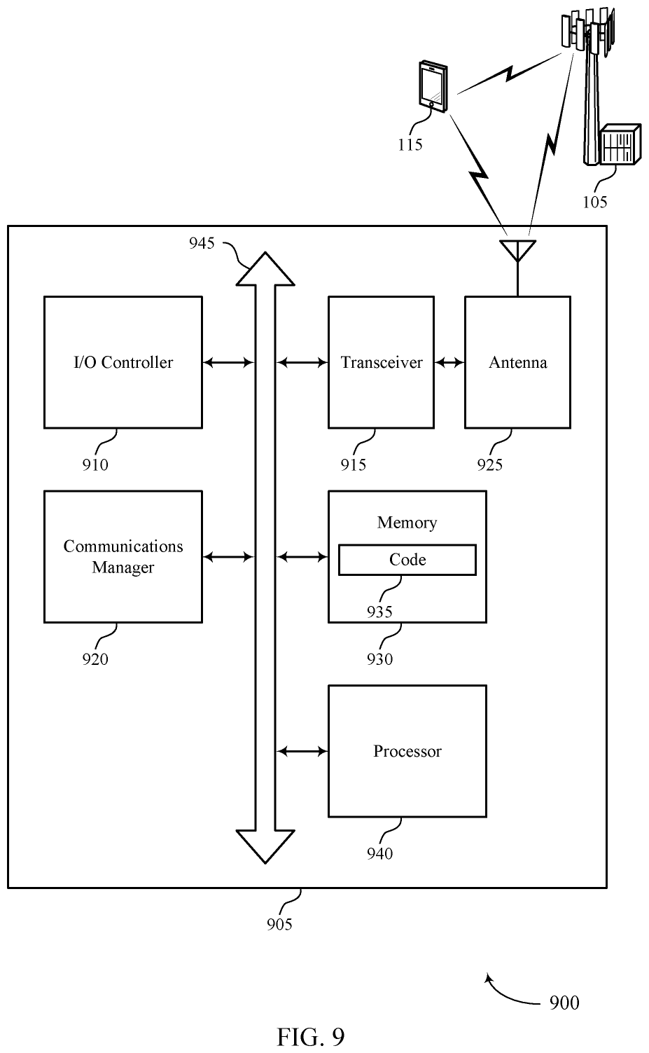

FIG. 9 shows a diagram of a system 900 including a device 905 that supports network operation time interval indication in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting network operation time interval indication). For example, the device 905 or a component of the device 905 may include a processor 940 and memory 930 coupled with or to the processor 940, the processor 940 and memory 930 configured to perform various functions described herein.

The communications manager 920 may support wireless communication at a UE in accordance with examples as disclosed herein. For example, the communications manager 920 may be configured as or otherwise support a means for receiving, from a network entity, control signaling indicating a set of multiple NES states of the network entity. The communications manager 920 may be configured as or otherwise support a means for communicating one or more messages with the network entity in accordance with a first NES state of the set of multiple NES states, the one or more messages being communicated based on a time period associated with the first NES state, based on receiving a control message indicating that the first NES state is active, or both.

By including or configuring the communications manager 920 in accordance with examples as described herein, the device 905 may support techniques for reduced latency, improved user experience related to reduced processing, reduced power consumption, and improved coordination between devices.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of network operation time interval indication as described herein, or the processor 940 and the memory 930 may be otherwise configured to perform or support such operations.

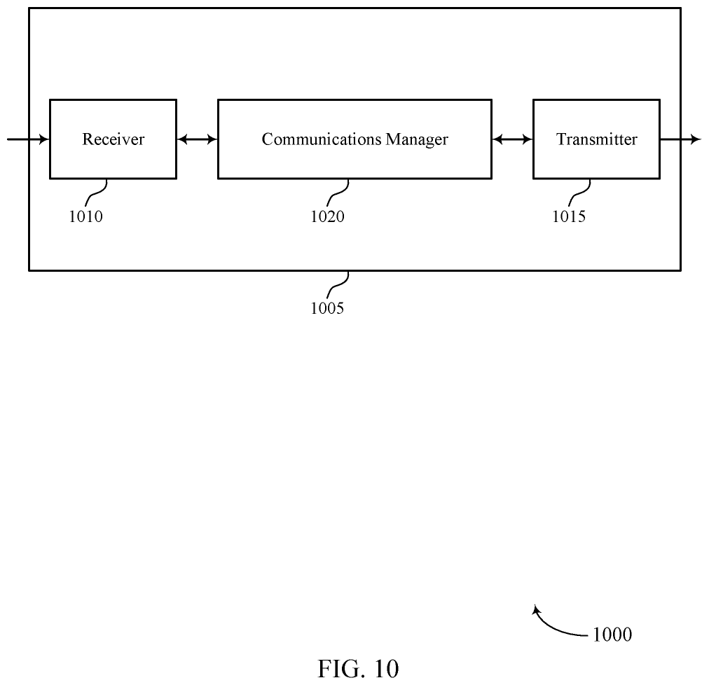

FIG. 10 shows a block diagram 1000 of a device 1005 that supports network operation time interval indication in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of network operation time interval indication as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. For example, the communications manager 1020 may be configured as or otherwise support a means for transmitting, to a UE, control signaling indicating a set of multiple NES states of the network entity. The communications manager 1020 may be configured as or otherwise support a means for operating in a first NES state of the set of multiple NES states based on a time period being associated with the first NES state, or based on a control message indicating that the first NES state is active. The communications manager 1020 may be configured as or otherwise support a means for communicating, with the UE, one or more messages in accordance with the first NES state.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for reduced power consumption and more efficient utilization of communication resources.

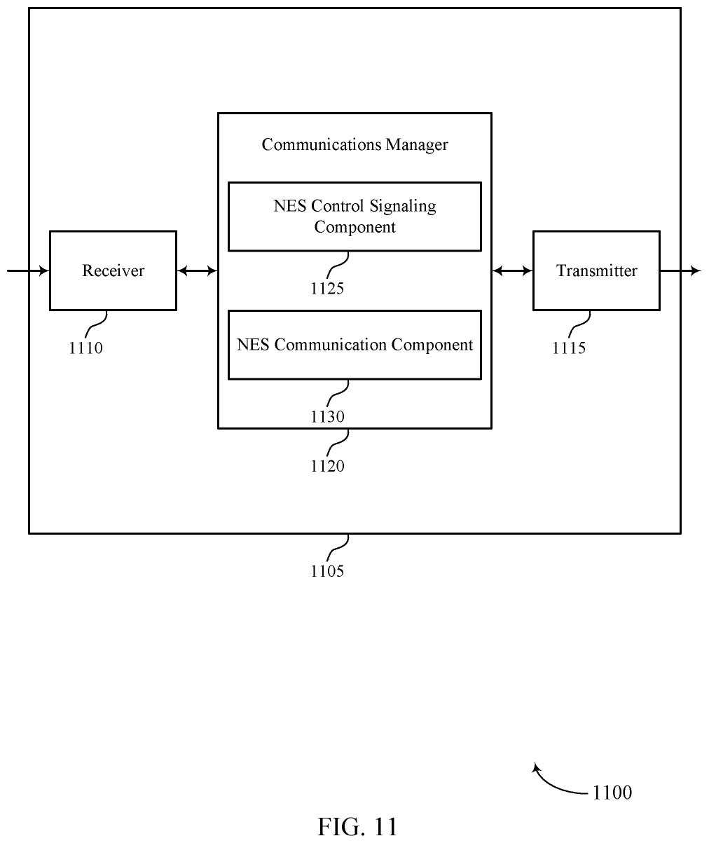

FIG. 11 shows a block diagram 1100 of a device 1105 that supports network operation time interval indication in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of network operation time interval indication as described herein. For example, the communications manager 1120 may include an NES control signaling component 1125 an NES communication component 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity in accordance with examples as disclosed herein. The NES control signaling component 1125 may be configured as or otherwise support a means for transmitting, to a UE, control signaling indicating a set of multiple NES states of the network entity. The NES communication component 1130 may be configured as or otherwise support a means for operating in a first NES state of the set of multiple NES states based on a time period being associated with the first NES state, or based on a control message indicating that the first NES state is active. The NES communication component 1130 may be configured as or otherwise support a means for communicating, with the UE, one or more messages in accordance with the first NES state.

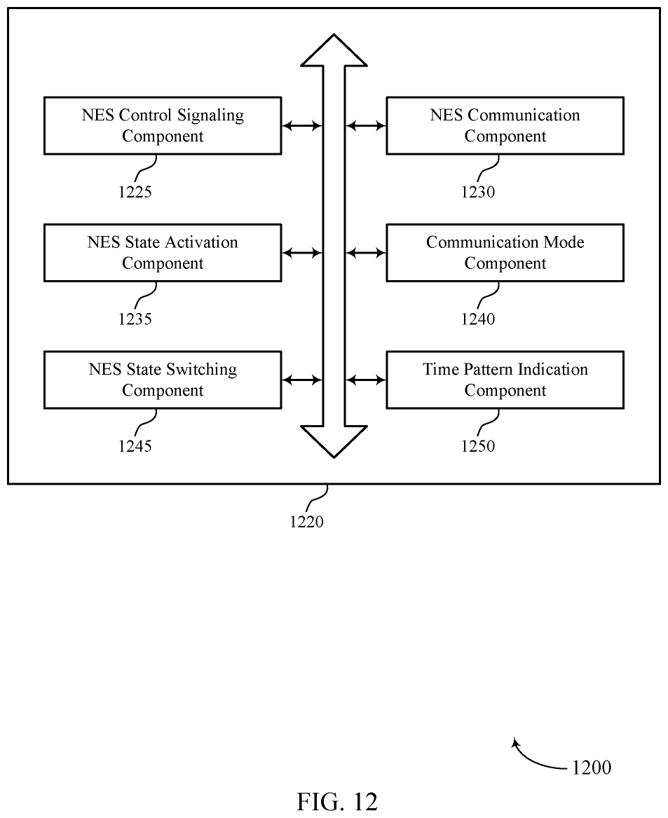

FIG. 12 shows a block diagram 1200 of a communications manager 1220 that supports network operation time interval indication in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of network operation time interval indication as described herein. For example, the communications manager 1220 may include an NES control signaling component 1225, an NES communication component 1230, an NES state activation component 1235, a communication state component 1240, an NES state switching component 1245, a time pattern indication component 1250, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication at a network entity in accordance with examples as disclosed herein. The NES control signaling component 1225 may be configured as or otherwise support a means for transmitting, to a UE, control signaling indicating a set of multiple NES states of the network entity. The NES communication component 1230 may be configured as or otherwise support a means for operating in a first NES state of the set of multiple NES states based on a time period being associated with the first NES state, or based on a control message indicating that the first NES state is active. In some examples, the NES communication component 1230 may be configured as or otherwise support a means for communicating, with the UE, one or more messages in accordance with the first NES state.

In some examples, to support communicating the one or more messages, the NES communication component 1230 may be configured as or otherwise support a means for communicating the one or more messages with the UE while operating in the first NES state based on a time pattern associated with the set of multiple NES states indicating that the network entity is operating in the first NES state.

In some examples, the time pattern indication component 1250 may be configured as or otherwise support a means for the control signaling indicating the time pattern associated with the set of multiple NES states.

In some examples, each time interval of a quantity of time intervals of the time pattern includes one or more symbols, one or more slots, one or more frames, one or more seconds, one or more milliseconds, one or more time periods, or any combination thereof.

In some examples, a duration of a respective time interval of a quantity of time intervals of the time pattern is based on a subcarrier spacing of the time pattern.

In some examples, the NES control signaling component 1225 may be configured as or otherwise support the set of multiple NES states including at least one of a baseline operating state, reduced power consumption state, a network support operation state, or a flexible operation state.

In some examples, to support communicating the one or more messages, the NES communication component 1230 may be configured as or otherwise support a means for communicating the one or more messages in accordance with the first NES state.

In some examples, the control signaling indicates a plurality of NES state patterns and the NES state activation component 1235 may be configured as or otherwise support a means for transmitting the control message that indicates an activated pattern of the set of multiple NES state patterns. In some examples, the control signaling indicates a plurality of NES state patterns and the NES state activation component 1235 may be configured as or otherwise support a means for operating in the first NES state based on the activated pattern.

In some examples, the activated pattern is based on at least one of a network load, one or more capabilities of the UE, or one or more NES parameters, or any combination thereof.

In some examples, the communication state component 1240 may be configured as or otherwise support a means for transmitting the control message that indicates that the network entity that is operating in the first NES state that is a flexible NES state or a default NES state.

In some examples, the NES state switching component 1245 may be configured as or otherwise support a means for switching, by the network entity, between two or more of the set of multiple NES states over time.

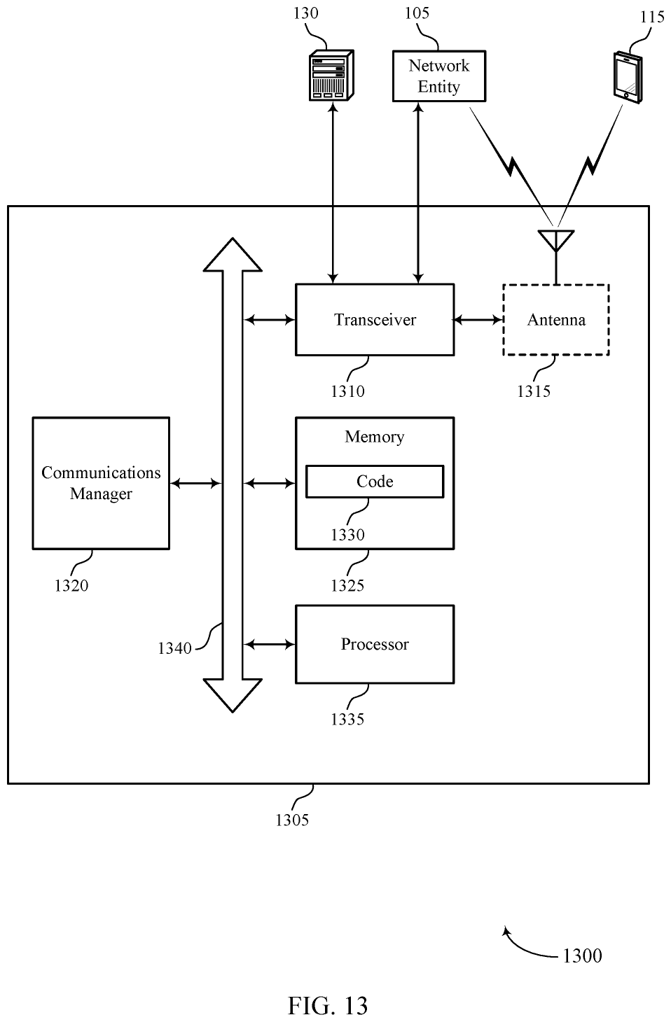

FIG. 13 shows a diagram of a system 1300 including a device 1305 that supports network operation time interval indication in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. The transceiver 1310, or the transceiver 1310 and one or more antennas 1315 or wired interfaces, where applicable, may be an example of a transmitter 1015, a transmitter 1115, a receiver 1010, a receiver 1110, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting network operation time interval indication). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and an interface to output information, or to obtain information, or both. The interface may be implemented as or otherwise include a first interface configured to output information and a second interface configured to obtain information. In some implementations, the first interface may refer to an interface between the processing system of the chip or modem and a transmitter, such that the device 1305 may transmit information output from the chip or modem. In some implementations, the second interface may refer to an interface between the processing system of the chip or modem and a receiver, such that the device 1305 may obtain information or signal inputs, and the information may be passed to the processing system. A person having ordinary skill in the art will readily recognize that the first interface also may obtain information or signal inputs, and the second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communication at a network entity in accordance with examples as disclosed herein. For example, the communications manager 1320 may be configured as or otherwise support a means for transmitting control signaling indicating a set of multiple NES states of the network entity. The communications manager 1320 may be configured as or otherwise support a means for operating in a first NES state of the set of multiple NES states based on a time period being associated with the first NES state, or based on transmitting, to the UE, a control message indicating that the first NES state is active. The communications manager 1320 may be configured as or otherwise support a means for communicating, with the UE, one or more messages in accordance with the first NES state.

By including or configuring the communications manager 1320 in accordance with examples as described herein, the device 1305 may support techniques for reduced latency, improved user experience related to reduced processing, reduced power consumption, and improved coordination between devices.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the processor 1335, the memory 1325, the code 1330, the transceiver 1310, or any combination thereof. For example, the code 1330 may include instructions executable by the processor 1335 to cause the device 1305 to perform various aspects of network operation time interval indication as described herein, or the processor 1335 and the memory 1325 may be otherwise configured to perform or support such operations.

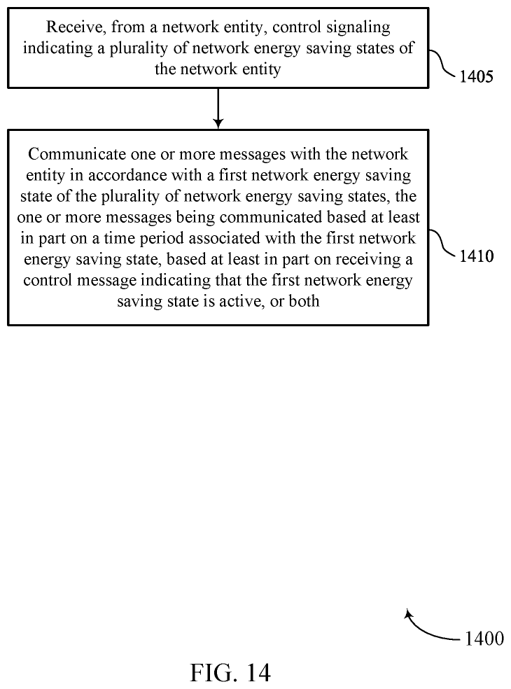

FIG. 14 shows a flowchart illustrating a method 1400 that supports network operation time interval indication in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving, from a network entity, control signaling indicating a set of multiple NES states of the network entity. The operations of 1405 may be performed in accordance with examples as disclosed herein. In some examples, aspects of the operations of 1405 may be performed by an NES control signaling component 825 as described with reference to FIG. 8.

At 1410, the method may include communicating one or more messages with the network entity in accordance with a first NES state of the set of multiple NES states, the one or more messages being communicated based on a time period associated with the first NES state, based on receiving a control message indicating that the first NES state is active, or both. The operations of 1410 may be performed in accordance with examples as disclosed herein. In some examples, aspects of the operations of 1410 may be performed by an NES communication component 830 as described with reference to FIG. 8.

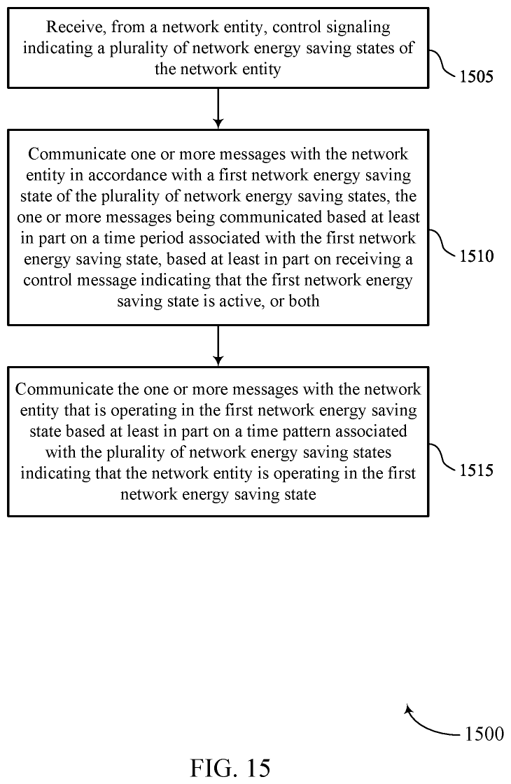

FIG. 15 shows a flowchart illustrating a method 1500 that supports network operation time interval indication in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving, from a network entity, control signaling indicating a set of multiple NES states of the network entity. The operations of 1505 may be performed in accordance with examples as disclosed herein. In some examples, aspects of the operations of 1505 may be performed by an NES control signaling component 825 as described with reference to FIG. 8.

At 1510, the method may include communicating one or more messages with the network entity in accordance with a first NES state of the set of multiple NES states, the one or more messages being communicated based on a time period associated with the first NES state, based on receiving a control message indicating that the first NES state is active, or both. The operations of 1510 may be performed in accordance with examples as disclosed herein. In some examples, aspects of the operations of 1510 may be performed by an NES communication component 830 as described with reference to FIG. 8.

At 1515, the method may include communicating the one or more messages with the network entity that is operating in the first NES state based on a time pattern associated with the set of multiple NES states indicating that the network entity is operating in the first NES state. The operations of 1515 may be performed in accordance with examples as disclosed herein. In some examples, aspects of the operations of 1515 may be performed by an NES communication component 830 as described with reference to FIG. 8.

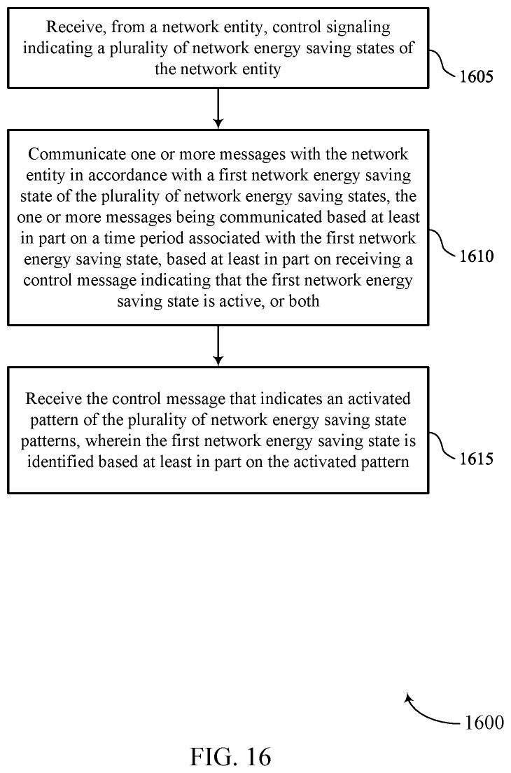

FIG. 16 shows a flowchart illustrating a method 1600 that supports network operation time interval indication in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include receiving, from a network entity, control signaling indicating a set of multiple NES states of the network entity. The operations of 1605 may be performed in accordance with examples as disclosed herein. In some examples, aspects of the operations of 1605 may be performed by an NES control signaling component 825 as described with reference to FIG. 8.

At 1610, the method may include communicating one or more messages with the network entity in accordance with a first NES state of the set of multiple NES states, the one or more messages being communicated based on a time period associated with the first NES state, based on receiving a control message indicating that the first NES state is active, or both. The operations of 1610 may be performed in accordance with examples as disclosed herein. In some examples, aspects of the operations of 1610 may be performed by an NES communication component 830 as described with reference to FIG. 8.

At 1615, the method may include receiving the control message that indicates an activated pattern of the set of multiple NES state patterns, where the first NES state is identified based on the activated pattern. The operations of 1615 may be performed in accordance with examples as disclosed herein. In some examples, aspects of the operations of 1615 may be performed by an NES state pattern configuration component 835 as described with reference to FIG. 8.

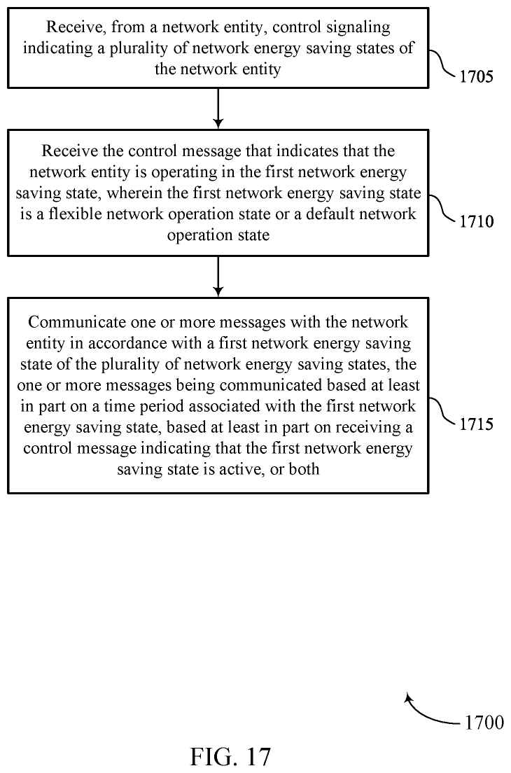

FIG. 17 shows a flowchart illustrating a method 1700 that supports network operation time interval indication in accordance with one or more aspects of the present disclosure. The operations of the method 1700 may be implemented by a UE or its components as described herein. For example, the operations of the method 1700 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1705, the method may include receiving, from a network entity, control signaling indicating a set of multiple NES states of the network entity. The operations of 1705 may be performed in accordance with examples as disclosed herein. In some examples, aspects of the operations of 1705 may be performed by an NES control signaling component 825 as described with reference to FIG. 8.

At 1710, the method may include receiving the control message that indicates that the network entity is operating in the first NES state, where the first NES state is a flexible NES state or a default NES state. The operations of 1710 may be performed in accordance with examples as disclosed herein. In some examples, aspects of the operations of 1710 may be performed by an NES state activation component 840 as described with reference to FIG. 8.

At 1715, the method may include communicating one or more messages with the network entity in accordance with a first NES state of the set of multiple NES states, the one or more messages being communicated based on a time period associated with the first NES state, based on receiving a control message indicating that the first NES state is active, or both. The operations of 1715 may be performed in accordance with examples as disclosed herein. In some examples, aspects of the operations of 1715 may be performed by an NES communication component 830 as described with reference to FIG. 8.

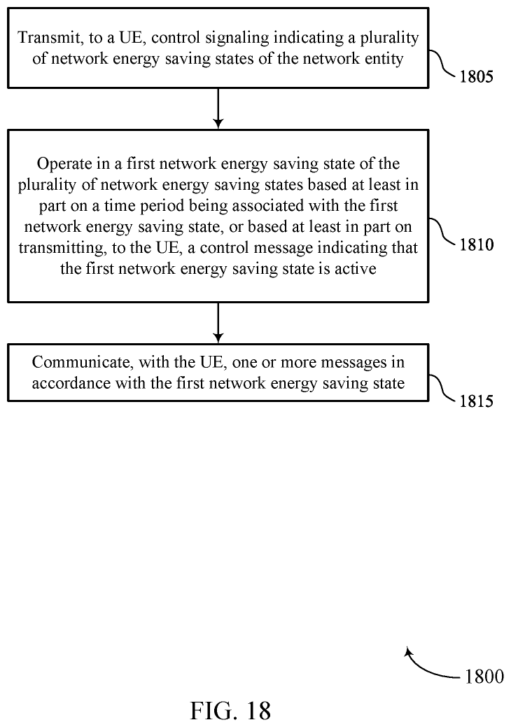

FIG. 18 shows a flowchart illustrating a method 1800 that supports network operation time interval indication in accordance with one or more aspects of the present disclosure. The operations of the method 1800 may be implemented by a network entity or its components as described herein. For example, the operations of the method 1800 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1805, the method may include transmitting, to a UE, control signaling indicating a set of multiple NES states of the network entity. The operations of 1805 may be performed in accordance with examples as disclosed herein. In some examples, aspects of the operations of 1805 may be performed by an NES control signaling component 1225 as described with reference to FIG. 12.

At 1810, the method may include operating in a first NES state of the set of multiple NES states based on a time period being associated with the first NES state, or based on transmitting a control message indicating that the first NES state is active. The operations of 1810 may be performed in accordance with examples as disclosed herein. In some examples, aspects of the operations of 1810 may be performed by an NES communication component 1230 as described with reference to FIG. 12.

At 1815, the method may include communicating, with the UE, one or more messages in accordance with the first NES state. The operations of 1815 may be performed in accordance with examples as disclosed herein. In some examples, aspects of the operations of 1815 may be performed by an NES communication component 1230 as described with reference to FIG. 12.

The following provides an overview of aspects of the present disclosure:

Aspect 1: A method for wireless communication at a UE, comprising: receiving, from a network entity, control signaling indicating a plurality of NES states of the network entity; and communicating one or more messages with the network entity in accordance with a first NES state of the plurality of NES states, the one or more messages being communicated based at least in part on a time period associated with the first NES state, based at least in part on a control message indicating that the first NES state is active, or both.

Aspect 2: The method of aspect 1, wherein communicating the one or more messages further comprises: communicating the one or more messages with the network entity that is operating in the first NES state based at least in part on a time pattern associated with the plurality of NES states indicating that the network entity is operating in the first NES state.

Aspect 3: The method of aspect 2, further comprising: receiving the control signaling indicating the time pattern associated with the plurality of NES states.

Aspect 4: The method of any of aspects 2 through 3, wherein each time interval of a quantity of time intervals of the time pattern comprises one or more symbols, one or more slots, one or more frames, one or more seconds, one or more milliseconds, one or more time periods, or any combination thereof.

Aspect 5: The method of any of aspects 2 through 4, wherein a duration of a respective time interval of a quantity of time intervals of the time pattern is based at least in part on a subcarrier spacing of the time pattern.

Aspect 6: The method of aspect 1, wherein the plurality of NES states comprise at least one of a baseline operating state, a reduced energy consumption state, a network support operation state, or a flexible operation state.

Aspect 7: The method of any of aspects 1 through 6, wherein communicating the one or more messages further comprises: receiving the control signaling or the control message that indicates one or more communication parameters associated with the first NES state; and communicating the one or more messages based at least in part on the one or more communication parameters that are associated with the first NES state.

Aspect 8: The method of any of aspects 1 through 7, wherein the control signaling indicates a plurality of NES state patterns and wherein the method further comprises: receiving the control message that indicates an activated pattern of the plurality of NES state patterns, wherein the first NES state is identified based at least in part on the activated pattern.

Aspect 9: The method of aspect 8, wherein the activated pattern is based at least in part on at least one of a network load, one or more capabilities of the UE, or one or more NES parameters, or any combination thereof.

Aspect 10: The method of any of aspects 1 through 9, further comprising: receiving the control message which indicates that the first NES state is active by indicating a change in one or more channel state information reference signal (CSI-RS) reporting configuration parameters, a change in an indicated transmission power of the network entity, or a change in one or more dynamic grant configurations for the one or more messages, or any combination thereof.

Aspect 11: The method of any of aspects 1 through 10, further comprising: receiving the control message that indicates that the network entity is operating in the first NES state, wherein the first NES state is a flexible NES state or a default NES state.

Aspect 12: The method of any of aspects 1 through 11, further comprising: modifying one or more transmission and reception parameters based at least in part on the first NES state, the one or more transmission and reception parameters comprising at least one of one or more uplink power control parameters, one or more antenna rank parameters, or one or more modulation and coding scheme parameters, or any combination thereof, and wherein the one or more messages are communicated based at least in part on the one or more transmission and reception parameters.

Aspect 13: The method of any of aspects 1 through 12, wherein communicating the one or more messages further comprises: modifying one or more communication techniques performed by the UE based at least in part on the first NES state, the one or more communication techniques comprising at least one of one or more uplink skipping techniques, one or more scheduling request procedures, one or more beam failure detection and recovery techniques, or one or more random access channel procedures, or any combination thereof.

Aspect 14: A method for wireless communication at a network entity, comprising: transmitting, to a UE, control signaling indicating a plurality of NES states of the network entity; operating in a first NES state of the plurality of NES states based at least in part on a time period being associated with the first NES state, or based at least in part on a control message indicating that the first NES state is active; and communicating, with the UE, one or more messages in accordance with the first NES state.

Aspect 15: The method of aspect 14, wherein communicating the one or more messages further comprises: communicating the one or more messages with the UE while operating in the first NES state based at least in part on a time pattern associated with the plurality of NES states indicating that the network entity is operating in the first NES state.

Aspect 16: The method of aspect 15, further comprising: transmitting, to the UE, the control signaling indicating the time pattern associated with the plurality of NES states.

Aspect 17: The method of any of aspects 15 through 16, wherein each time interval of a quantity of time intervals of the time pattern comprises one or more symbols, one or more slots, one or more frames, one or more seconds, one or more milliseconds, one or more time periods, or any combination thereof.

Aspect 18: The method of any of aspects 15 through 17, wherein a duration of a respective time interval of a quantity of time intervals of the time pattern is based at least in part on a subcarrier spacing of the time pattern.

Aspect 19: The method of any of aspects 14 through 18, wherein the plurality of NES states comprise at least one of a baseline operating state, a reduced power consumption state, a network support operation state, or a flexible operation state.

Aspect 20: The method of any of aspects 14 through, wherein communicating the one or more messages further comprises: transmitting, to the UE, the control signaling or the control message that indicates one or more communication parameters associated with the first NES state; and communicating the one or more messages in accordance with the first NES state.

Aspect 21: The method of any of aspects 14 through 20, wherein the control signaling indicates a plurality of NES state patterns and wherein the method further comprises: transmitting, to the UE, the control message that indicates an activated pattern of the plurality of NES state patterns; and operating in the first NES state based at least in part on the activated pattern.

Aspect 22: The method of aspect 21, wherein the activated pattern is based at least in part on at least one of a network load, one or more capabilities of the UE, or one or more NES parameters, or any combination thereof.

Aspect 23: The method of any of aspects 14 through 22, further comprising: transmitting, to the UE, the control message that indicates that the network entity that is operating in the first NES state that is a flexible NES state or a default NES state.

Aspect 24: The method of any of aspects 14 through 23, further comprising: switching, by the network entity, between two or more of the plurality of NES states over time.

Aspect 25: An apparatus for wireless communication at a UE, comprising a processor; memory coupled with the processor; and instructions stored in the memory and executable by the processor to cause the apparatus to perform a method of any of aspects 1 through 13.

Aspect 26: An apparatus for wireless communication at a UE, comprising at least one means for performing a method of any of aspects 1 through 13.

Aspect 27: A non-transitory computer-readable medium storing code for wireless communication at a UE, the code comprising instructions executable by a processor to perform a method of any of aspects 1 through 13.

Aspect 28: An apparatus for wireless communication at a network entity, comprising a processor; memory coupled with the processor; and instructions stored in the memory and executable by the processor to cause the apparatus to perform a method of any of aspects 14 through 24.

Aspect 29: An apparatus for wireless communication at a network entity, comprising at least one means for performing a method of any of aspects 14 through 24.

Aspect 30: A non-transitory computer-readable medium storing code for wireless communication at a network entity, the code comprising instructions executable by a processor to perform a method of any of aspects 14 through 24.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor;
memory coupled with the processor; and
instructions stored in the memory and executable by the processor to cause the apparatus to:
receive, from a network entity, control signaling indicating a plurality of network energy saving states of the network entity; and
communicate one or more messages with the network entity in accordance with a first network energy saving state of the plurality of network energy saving states, the one or more messages being communicated based at least in part on a time period associated with the first network energy saving state, based at least in part on a control message indicating that the first network energy saving state is active, or both.

2. The apparatus of claim 1, wherein the instructions to communicate the one or more messages are further executable by the processor to cause the apparatus to:
communicate the one or more messages with the network entity that is operating in the first network energy saving state based at least in part on a time pattern associated with the plurality of network energy saving states indicating that the network entity is operating in the first network energy saving state.

3. The apparatus of claim 2, wherein the control signaling indicates the time pattern associated with the plurality of network energy saving states.

4. The apparatus of claim 2, wherein:
each time interval of a quantity of time intervals of the time pattern comprises one or more symbols, one or more slots, one or more frames, one or more seconds, one or more milliseconds, one or more time periods, or any combination thereof.

5. The apparatus of claim 2, wherein:
a duration of a respective time interval of a quantity of time intervals of the time pattern is based at least in part on a subcarrier spacing of the time pattern.

6. The apparatus of claim 1, wherein the plurality of network energy saving states comprises at least one of a baseline operating state, a reduced energy consumption state, a network support operation state, or a flexible operation state.

7. The apparatus of claim 1, wherein the control signaling or the control message indicates one or more communication parameters associated with the first network energy saving state, and wherein the instructions to communicate the one or more messages are further executable by the processor to cause the apparatus to:
communicate the one or more messages based at least in part on the one or more communication parameters that are associated with the first network energy saving state.

8. The apparatus of claim 1, wherein the control signaling indicates a plurality of network energy saving state patterns and wherein the instructions are further executable by the processor to cause the apparatus to:
receive the control message that indicates an activated pattern of the plurality of network energy saving state patterns, wherein the first network energy saving state is identified based at least in part on the activated pattern.

9. The apparatus of claim 8, wherein:
the activated pattern is based at least in part on at least one of a network load, one or more capabilities of the UE, or one or more network energy saving parameters, or any combination thereof.

10. The apparatus of claim 1, wherein the instructions are further executable by the processor to cause the apparatus to:
receive the control message which indicates that the first network energy saving state is active by indicating a change in one or more channel state information reference signal (CSI-RS) reporting configuration parameters, a change in an indicated transmission power of the network entity, or a change in one or more dynamic grant configurations for the one or more messages, or any combination thereof.

11. The apparatus of claim 1, wherein the instructions are further executable by the processor to cause the apparatus to:
receive the control message that indicates that the network entity is operating in the first network energy saving state, wherein the first network energy saving state is a flexible network energy saving state or a default network energy saving state.

12. The apparatus of claim 1, wherein the instructions are further executable by the processor to cause the apparatus to:
modify one or more transmission and reception parameters based at least in part on the first network energy saving state, the one or more transmission and reception parameters comprising at least one of one or more uplink power control parameters, one or more antenna rank parameters, or one or more modulation and coding scheme parameters, or any combination thereof, and wherein the one or more messages are communicated based at least in part on the one or more transmission and reception parameters.

13. The apparatus of claim 1, wherein:
the control signaling or the control message indicates one or more communication parameters associated with the first network energy saving state, and wherein the instructions to communicate the one or more messages are further executable by the processor to cause the apparatus to:
modify one or more communication techniques performed by the UE to communicate the one or more messages with the network entity based at least in part on the first network energy saving state, the one or more communication techniques comprising at least one of one or more uplink skipping techniques, one or more scheduling request procedures, one or more beam failure detection and recovery techniques, or one or more random access channel procedures, or any combination thereof.

14. An apparatus for wireless communication at a network entity, comprising:
a processor;
memory coupled with the processor; and
instructions stored in the memory and executable by the processor to cause the apparatus to:
transmit, to a user equipment (UE), control signaling indicating a plurality of network energy saving states of the network entity;
operate in a first network energy saving state of the plurality of network energy saving states based at least in part on a time period being associated with the first network energy saving state, or based at least in part on a control message indicating that the first network energy saving state is active; and
communicate, with the UE, one or more messages in accordance with the first network energy saving state.

15. The apparatus of claim 14, wherein the instructions to communicate the one or more messages are further executable by the processor to cause the apparatus to:
communicate the one or more messages with the UE while operating in the first network energy saving state based at least in part on a time pattern associated with the plurality of network energy saving states indicating that the network entity is operating in the first network energy saving state.

16. The apparatus of claim 15, wherein the control signaling indicates the time pattern associated with the plurality of network energy saving states.

17. The apparatus of claim 15, wherein:
each time interval of a quantity of time intervals of the time pattern comprises one or more symbols, one or more slots, one or more frames, one or more seconds, one or more milliseconds, one or more time periods, or any combination thereof.

18. The apparatus of claim 15, wherein:
a duration of a respective time interval of a quantity of time intervals of the time pattern is based at least in part on a subcarrier spacing of the time pattern.

19. The apparatus of claim 14, wherein:
the plurality of network energy saving states comprise at least one of a baseline operating state, a reduced energy consumption state, a network support operation state, or a flexible operation state.

20. The apparatus of claim 14, wherein:
the control signaling or the control message indicates one or more communication parameters associated with the first network energy saving state, and wherein the instructions to communicate the one or more messages are further executable by the processor to cause the apparatus to:
communicate the one or more messages in accordance with the first network energy saving state.

21. The apparatus of claim 14, wherein:
the control signaling indicates a plurality of network energy saving state patterns and wherein, and the instructions are further executable by the processor to cause the apparatus to:
transmit, to the UE, the control message that indicates an activated pattern of the plurality of network energy saving state patterns; and
operate in the first network energy saving state based at least in part on the activated pattern.

22. The apparatus of claim 21, wherein:
the activated pattern is based at least in part on at least one of a network load, one or more capabilities of the UE, or one or more network energy saving parameters, or any combination thereof.

23. The apparatus of claim 14, wherein the instructions are further executable by the processor to cause the apparatus to:
transmit, to the UE, the control message that indicates that the network entity that is operating in the first network energy saving state that is a flexible network energy saving state or a default network energy saving state.

24. The apparatus of claim 14, wherein the instructions are further executable by the processor to cause the apparatus to:
switching, by the network entity, between two or more of the plurality of network energy saving states over time.

25. A method for wireless communication at a user equipment (UE), comprising:
receiving, from a network entity, control signaling indicating a plurality of network energy saving states of the network entity; and
communicating one or more messages with the network entity in accordance with a first network energy saving state of the plurality of network energy saving states, the one or more messages being communicated based at least in part on a time period associated with the first network energy saving state, based at least in part on a control message indicating that the first network energy saving state is active, or both.

26. The method of claim 25, wherein communicating the one or more messages further comprises:
communicating the one or more messages with the network entity that is operating in the first network energy saving state based at least in part on a time pattern associated with the plurality of network energy saving states indicating that the network entity is operating in the first network energy saving state.

27. The method of claim 26, wherein the control signaling indicates the time pattern associated with the plurality of network energy saving states.

28. The method of claim 26, wherein:
each time interval of a quantity of time intervals of the time pattern comprises one or more symbols, one or more slots, one or more frames, one or more seconds, one or more milliseconds, one or more time periods, or any combination thereof.

29. The method of claim 26, wherein:
a duration of a respective time interval of a quantity of time intervals of the time pattern is based at least in part on a subcarrier spacing of the time pattern.

30. A method for wireless communication at a network entity, comprising:
transmitting, to a user equipment (UE), control signaling indicating a plurality of network energy saving states of the network entity;
operating in a first network energy saving state of the plurality of network energy saving states based at least in part on a time period being associated with the first network energy saving state, or based at least in part on a control message indicating that the first network energy saving state is active; and
communicating, with the UE, one or more messages in accordance with the first network energy saving state.
